(19) United States
(12) Patent Application Publication
(10) Pub. No.: US 2009/0264065 A1
(43) Pub. Date: Oct. 22, 2009

(54) CIRCUIT FOR COMPENSATING PASSBAND FLATNESS, APPARATUS AND METHOD FOR COMPENSATING PASSBAND FLATNESS

(75) Inventor: Youngbum SONG, Gyeonggi-do (KR)

Correspondence Address: HOSOON LEE, 9600 SW OAK ST. SUITE 525, TIGARD, OR, 97223, US

(73) Assignee: EC TELECOM CO., LTD., Gyeonggi-do (KR)

(21) Appl. No.: 12/420,776

(22) Filed: Apr. 8, 2009

(30) Foreign Application Priority Data
Apr. 18, 2008 (KR) 2008-0036287

(51) Int. Cl. H04B 7/14

(52) U.S. Cl. 455/8

(57) ABSTRACT

Disclosed is an apparatus for compensating passband flatness according to the present invention. The apparatus for compensating passband flatness for a mobile communication repeater to compensate passband flatness of band passed input signals comprises: a circuit for compensating passband flatness that includes a varactor diode formed to be connected to an inductance element to correct micro resonance frequencies for passbands of input signals according to voltages applied from the outside; and a controller that controls voltages input to the circuit for compensating passband flatness and varies the voltages applied to the varactor diode of the circuit for compensating passband flatness based on preset voltage values applied to the varactor diode so that passband flatness characteristics are compensated according to the corresponding frequency bands.

This application claims the benefit of Korean Patent Application No. 10-2008-0036287. filed on Apr. 18, 2008, which is hereby incorporated by a reference in its entirety.

### BACKGROUND OF THE INVENTION

1. Field of the Invention

The present invention relates to a circuit for compensating passband flatness and an apparatus and method for compensating passband flatness and in particular, to a circuit for compensating passband flatness and an apparatus and method for compensating passband flatness, which can vary and compensate the passband flatness for the repeater for each frequency band.

2. Description of the Related Art

Currently, due to the advance of an information-oriented society, a person can freely communicate with other people regardless of time and place. As a result, a technology for improving communication quality is being continuously developed.

Repeaters developed to improve communication quality of mobile communication and overcome a communication dead zone are currently installed over several areas. This repeater inputs signals from a base station, which are received in an antenna, to a downlink via a duplexer, amplifies the signals in an amplifier, synthesizes the amplified signals in a duplexer of an output end, and then radiates the synthesized signals to shadow zones.

In contrast, signals from subscribers within the shadow zones are input to the duplexer, amplified in a power amplifier and an amplifier of an uplink, and radiated toward the base station. Accordingly, each signal is simultaneously transmitted using two paths to provide communication services to the shadow zones. The repeater using the above scheme detects the signals by a band pass filter and amplifies the detected signals in the amplifier, such that communication services can be provided for small-scale areas interrupted or isolated from the outside.

However, the repeater of the related art has difficulty in detecting the corresponding signals or significantly deteriorates signal quality when passband flatness in the band pass filter is poor. Therefore, the repeater should be designed to maintain optimal passband flatness. However, not only is the cost for manufacturing the band pass filter to have desired passband flatness characteristics high, it is also complex.

As a result, the related art is configured to include a circuit for compensating passband flatness in consideration of designing the repeater so as to compensate the passband flatness.

FIG. 1 is a diagram showing an example of the circuit for compensating passband flatness according to the related art. The compensation circuit shown is connected to a rear end of a band pass filter having distorted flatness characteristics to improve the passband flatness. At this lime, the compensation circuit is configured to include variable capacitors C1 and C2, an inductor L, a variable resistor R5, and passive elements R1 to R5. C3, and C4 in order to compensate flatness characteristics. And, the circuit for compensating passband flatness according to the related art can compensate the passband flatness for the band pass filter only in a specific frequency band.

Therefore, the circuit for compensating passband flatness according to the related art controls the passband flatness by manually changing or replacing the values of the capacitors C1 and C2, the inductor L, and the resistor R5 for each frequency band used in the repeater, such that a manufacturer can have the desired passband flatness characteristics. In other words, the circuit for compensating passband flatness according to the related art should manually change the capacitor or other passive elements whenever service frequency bands are changed so as to compensate the passband flatness.

Further, the circuit for compensating passband flatness according to the related art is extremely limited in narrowing or expanding a band and is sensitive to change in a signal, such that it can be used in a place where a frequency is fixed but cannot be used in a place where a frequency is variable.

For example, in the case of personal communication services (PCS) used in the US. the entire band is 65 MHz up to “A to G” Band (Downlink : 1930 to 1935. Uplink : 1850 to 1915 MHz), but an actual service band does not use the entire band. In other words, the actual service band of the PCS combines bandwidths such as 5 MHz. 10 MHz. 15 MHz for each area over a band of 65 MHz and variably allocates the bandwidths. Therefore, there is a problem in that the circuit for compensating passband flatness included in the repeater installed in each area should be changed to have the desired passband flatness characteristics or the capacitor or other passive elements should be manually changed.

As such, the circuit for compensating passband flatness for a repeater according to the related art should compensate the passband flatness by disassembling the finished product whenever the frequency is changed and then reassembled. In addition, the related art should change elements whenever the service bands are changed so as to compensate the passband flatness. As a result, the related art has many problems in that the product should be delivered to the manufacturer and then readjusted if the passband flatness of the installed repeater needs to be compensated, etc.

### SUMMARY Of THE INVENTION

The present invention proposes to solve the above problems. It is an object of the present invention to provide a circuit for compensating passband flatness and an apparatus and method for compensating passband flatness, which can vary and compensate the passband flatness of the circuit for compensating passband flatness whenever the frequency is changed.

Further, it is another object of the present invention to provide a circuit for compensating passband flatness and an apparatus and method for compensating passband flatness, which can easily control passband flatness according to preset table values in controlling passband flatness for a mobile communication repeater.

There is provided an apparatus for compensating passband flatness according to an exemplary embodiment of the present invention. The apparatus for compensating passband flatness for a mobile communication repealer to compensate passband flatness of band passed input signals comprises: a circuit for compensating passband flatness that includes a varactor diode formed to be connected to an inductance element to correct micro resonance frequencies of the passbands of the input signals according to voltages applied from outside: and a controller that variably controls voltages input to the circuit for compensating passband flatness according to current frequency bands and varies the voltages applied to the varactor diode of the circuit for compensating passband flatness based on preset voltage values applied to the varactor diode so that passband flatness characteristics are compensated according to the corresponding frequency bands.

Preferably, the present invention further comprises a storage unit that stores a table having the preset voltage values applied to the varactor diode so that the passband flatness characteristics are compensated according to the corresponding frequency bands, wherein the controller variably controls the voltages input to the circuit for compensating passband flatness according to the current frequency bands based on the table stored in the storage unit.

Preferably, the present invention further comprises a key input unit that receives setting values for the current frequency bands, wherein the controller loads the table stored in the storage unit according to the setting values for the current frequency bands input from the key input unit and inputs the corresponding voltage values to the circuit for compensating passband flatness.

Preferably, the present invention further comprises a display unit that displays the table stored in the storage unit in a user interface form.

Preferably, the circuit for compensating passband flatness includes a basic resonance element unit that determines the passbands of the inputs signals: and the varactor diode formed to be connected to the inductance element to correct the micro resonance frequency for the passband of the basic resonance element unit according to the voltages applied from the outside.

Preferably, the varactor diode is connected to the inductance element in parallel.

There is provided a method for compensating passband flatness according to another exemplary embodiment of the present invention. The method for compensating passband flatness for a mobile communication repeater to compensate passband flatness of a band passed input signal comprises: receiving setting values of current frequency bands from the outside; loading preset voltage values applied to a varactor diode to compensate passband flatness characteristics according to the setting values of the input current frequency bands; and variably controlling voltages input to a circuit for compensating passband flatness that includes a varactor diode formed to be connected to an inductance element to correct micro resonance frequencies for the passbands of the input signals according to the voltages applied from the outside based on the loaded value voltage.

Preferably, the present invention further comprises storing a table having the preset voltage values applied to the varactor diode so that the passband flatness characteristics are compensated according to the corresponding frequency bands, wherein variably controlling controls of the voltages input to the circuit for compensating passband flatness according to the current frequency bands based on the table stored in the storing step.

Preferably, the controlling loads the table stored in the storing step according to the setting values for the current frequency bands input in the inputting step and input the corresponding voltage values to the circuit for compensating passband flatness.

Preferably, the present invention further comprises displaying the table stored in the storing step in a user interface form.

There is provided a circuit for compensating passband flatness for a mobile communication repeater according to a still another exemplary embodiment of the present invention. The circuit for compensating passband flatness for a mobile communication repeater to compensate flatness of band passed input signals comprises: a basic resonance element unit that determines passbands of the inputs signals: and a varactor diode formed to be connected to the inductance element to correct the micro resonance frequencies for the passband of the basic resonance element unit according to the voltages applied from the outside.

Preferably, the varactor diode is connected to the inductance clement in parallel.

There is provided a mobile communication repeater according to a further still another exemplary embodiment of the present invention. The mobile communication repeater comprises: a circuit for compensating passband flatness that includes a varactor diode formed to be connected to an inductance element to correct micro resonance frequencies for passbands of input signals according to voltages applied from the outside: and a controller that controls voltages input to the circuit for compensating passband flatness according to a current frequency band and varies the voltages applied to the varactor diode of the circuit for compensating passband flatness based on preset voltage values applied to the varactor diode so that passband flatness characteristics are compensated according to the corresponding frequency bands.

With the present invention, the manufacturer can simply control the passband flatness of the mobile communication repeater, such that the problem of opening the finished products and the inconvenience of recalling the installed repeater due to the defect of the passband flatness can be remarkably reduced.

Further, with the present invention, difficulty in implementing the passband flatness characteristics can be solved, the repeater meeting the wide band service and the used variable band characteristics can be easily developed, and the mass-productivity of the developed repeater can be increased. In other words, with the present invention, the time needed for development and the production costs of the repeater can be reduced, while still maintaining the best signal quality when the excellent passband flatness is maintained.

### BRIEF DESCRIPTION OF THE DRAWINGS

FIG. 1 is an exemplified diagram showing a circuit for compensating passband flatness according to the related art:

FIG. 2 is a block configuration diagram of a repeater showing an example to which an apparatus for compensating variable passband flatness for a repeater according to an exemplary embodiment of the present invention is applied;

FIG. 3 is a block diagram showing an apparatus for compensating variable passband flatness for a repeater according to an exemplary embodiment of the present invention;

FIG. 4 is a circuit diagram showing a circuit for compensating passband flatness shown in FIG. 3:

FIG. 5 is an exemplified diagram showing passband flatness compensation according to an exemplary embodiment of the present invention:

FIG. 6 is an exemplified diagram for explaining passband flatness compensation method according to an exemplary embodiment of the present invention;

FIG. 7 is a flow chart showing a method for compensating passband flatness according to an exemplary embodiment of the present invention;

FIG. 8 is a screen for setting frequency bands displayed on a display unit;

FIG. 9 is a graphical user interface screen; and

FIG. 10 is a graph showing actually measured resonance characteristics of a circuit for compensating passband flatness for a mobile communication repeater according to an exemplary embodiment of the present invention.

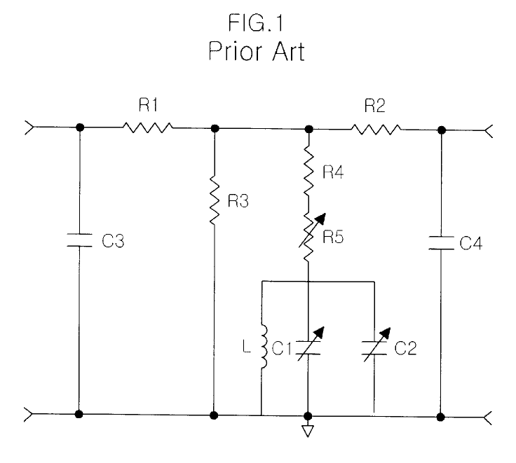

### DESCRIPTION OF THE PREFERRED EMBODIMENTS

Hereinafter, exemplary embodiment the present invention will be described in detail with reference to the accompanying drawings. Herein, the detailed description of a related known function or configuration that may make the purpose of the present invention unnecessarily ambiguous in describing the present invention will be omitted. Exemplary embodiments are provided so that those skilled in the art may more completely understand the present invention. Accordingly, the shape, the size, etc., of elements in the figures may be exaggerated for explicit comprehension. Like reference numerals refer to the like elements throughout the drawings.

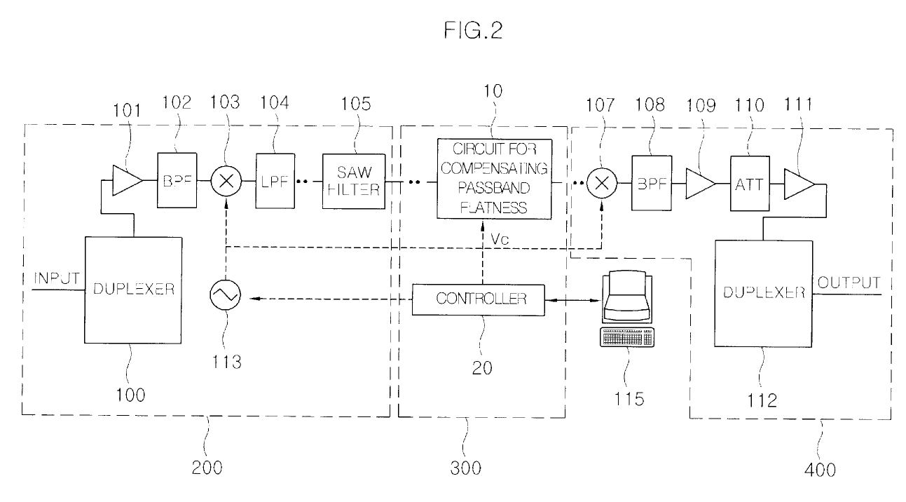

FIG. 2 is a block configuration diagram of a repeater showing an example to which an apparatus for compensating variable passband flatness for a repeater according to an exemplary embodiment of the present invention is applied.

Referring to FIG. 2, a mobile communication repeater to which an apparatus for compensating variable passband flatness for a repeater according to an exemplary embodiment of the present invention is applied includes an input circuit 200 that bandpasses and detects input signals, an apparatus 300 for compensating passband flatness that corrects passband flatness of the bandpassed signals according to an exemplary embodiment of the present invention, and an output circuit 400 that outputs processed signals.

The input circuit 200 is generally a circuit that bandpasses signals from a base station, which are received in an antenna of a repeater, to detect desired signals. The input circuit 200 may be configured to include a duplexer 100, a low noise AMP 101, a band pass filter 102, a down conversion mixer 103, an LPF 104, and an SAW filter 105. It can be appreciated from those skilled in the art that a configuration of the input circuit 200 may be formed in different forms according to an environment of the repeater.

The output circuit 400 is a circuit that amplifies the signals whose passband flatness of the band passed input signals is compensated by the apparatus 300 for compensating passband flatness as described below and then radiates them to shadow zones through the antenna. The output circuit 400 may be configured to include an up conversion mixer 107, a band pass filter 108, a drive AMP 109, a digital attenuator 110, a high power AMP 111, a duplexer 112, and a phase locked loop 113. It can be appreciated from those skilled in the art that a configuration of the output circuit 400 may be formed in different forms according to an environment of the repeater.

Herein, the duplexers 100 and 112 perform a role of passing only use band signals and removing other band signals and the low noise AMP 101 and the band pass filter 102 perform a role of amplifying the input signals in a low noise manner and passing only use bands. The down conversion mixer 103 performs a role of down-converting a frequency into an intermediate frequency IF using a signal from a phase locked loop 113 and an LPF 104 performs a role of removing spurious signals in the converted signals. The SAW filter 105 is used to remove the spurious signals in the converted signals and improve a filtering characteristic of the use band. The up converter mixer 107 performs a role of up-converting the intermediate frequency (IF) band into an originally used frequency band. The band pass filter 108 performs a role of passing only the use band signals and removing other band signals and the drive AMP 109 performs a role of amplifying the passband of the band signal. The digital attenuator 110 performs a role of controlling the passband of the repeater and the high power AMP 111 performs a role of amplifying the signal to the required final output in the repeater. It can be appreciated from those skilled in the art that the configurations of the above-mentioned input circuit 200 and output circuit 400 are not limited thereto, but can be changed according to the role or kind of the repeater.

Generally, when the passband flatness for the band passed signals is poor in the input circuit 200 of the repeater, it is difficult detect the corresponding signals or the signal quality thereof is seriously degraded. Therefore, the apparatus 300 for compensating passband flatness according to an exemplary embodiment of the present invention performs a role of compensating the passband flatness of the band passed signals.

The apparatus 300 for compensating passband flatness is configured to correct micro resonance frequencies for the passbands for the input signals according to a voltage Vc that is supplied from the outside. The apparatus 300 for compensating passband flatness includes a circuit 10 for compensating passband flatness that includes a varactor diode formed to be connected to an inductance element and a controller 20 that controls the passband flatness compensation by varying the voltage Vc applied to the circuit for compensating passband flatness into preset voltage values according to the frequency bands.

Further, the apparatus 300 for compensating passband flatness may perform a role of a digital control board that automatically controls operations of the repeater, such as output and alarm setting of the repeater, etc.

Preferably, the repeater further includes a setting terminal 115 that is linked with the apparatus 300 for compensating passband flatness to set the operations of the repeater, and setting and alarm monitoring of the repeater.

Hereinafter, the apparatus for compensating passband flatness according to an exemplary embodiment of the present invention will be described with reference to the accompanying drawings. In the following description the configuration of the above-mentioned repeater will be described but a description of a general configuration will not be described.

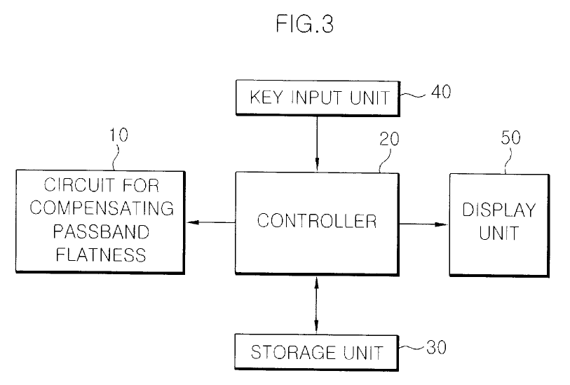

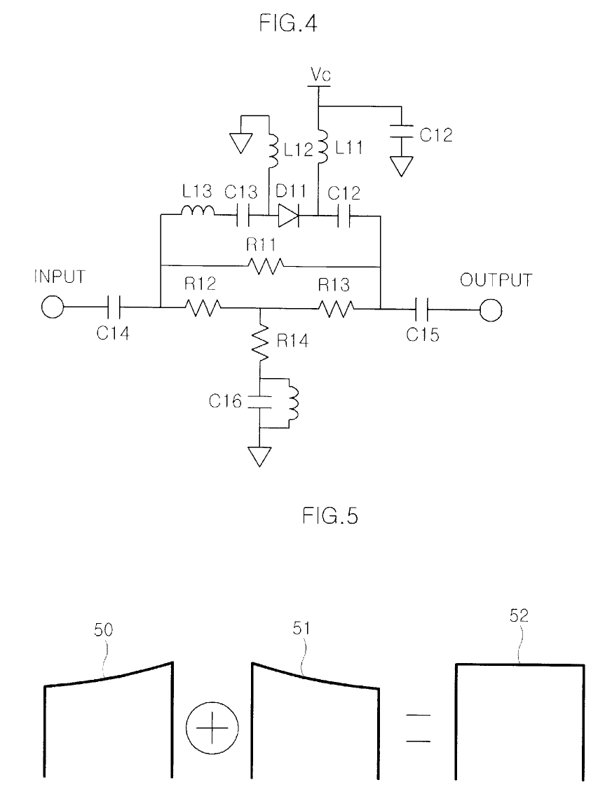

FIG. 3 is a block diagram showing an apparatus for compensating passband flatness for a repeater according to an exemplary embodiment of the present invention and FIG. 4 is a circuit diagram showing a circuit for compensating passband flatness shown in FIG. 3.

Referring to FIG. 3, the apparatus 300 for compensating passband flatness according to the exemplary embodiment of the present invention is configured to include the circuit 10 for compensating passband flatness, the controller 20, a storage unit 3, a key input unit 40, and a display unit 50.

The circuit 10 for compensating passband flatness performs a role of a kind of a variable resonance circuit that is used to compensate the passband flatness characteristics of the mobile communication repeater shown in FIG. 2. The circuit 10 for compensating passband flatness compensates the passband flatness for the mobile communication repeater to compensate the flatness of the bandpassed input signals input through the input and outputs the compensated input signals as an output signal, as shown in FIG. 4. And, the circuit 10 for compensating passband flatness is configured to include basic resonance element units C16, C14, and R14 that determines the passbands of the input signals, a varactor diode D11 that is formed to be connected to an inductance element L13 to correct the micro resonance frequencies for the passbands of the basic resonance element units C16, C14, and R14 according to voltages applied from the outside, and elements configuring the circuit.

Herein, among the basic resonance element units, the capacitance of reference numeral C16 and the inductance of reference numeral L14 determine the passband of the resonance circuit. And, the inductance element L13 and the varactor diode D11 are important elements to compensate the passband flatness, wherein the passband flatness is compensated which is varied in response to the voltage Vc applied to the varactor diode D11 with the inductor value of the inductance element L13 is fixed. For example, when the band passed signal passing through the input circuit 200 shown in FIG. 2 has ripple or non-uniform signal characteristics, circuit 10 for compensating passband flatness performs a role of band pass filter complementarily compensating them to output uniform signals and output them to the output circuit 400, thereby making the mobile communication stable.

And, the capacitance of reference numerals C12, C13, C14, and C15 that are elements configuring the circuit is coupling capacitance that passes AC signals and blocks DC signal. And, reference numerals C11, L11, and L12 are a by-pass capacitor and a chalk coil that remove noise components of the input voltage. Further, the resistance of reference numerals R11, R12, and R13 performs a role of matching and balancing impedance at inputs and outputs of circuit (10). Since those skilled in the art can understand this configuration, the detailed description thereof will not be repeated.

Therefore, since the circuit 10 for compensating passband flatness can vary the voltage applied to the varactor diode D11, it can control to achieve the appropriate passband flatness compensation according to the frequency bands from the outside or remotely by controlling the voltage Vc using the controller 20 from the outside, without changing the internal configuration of the circuit 10 for compensating passband flatness even when the frequencies are changed or the service bands are changed.

The controller 20 performs a role of controlling the voltage value applied to the varactor diode D11 of the circuit 10 for compensating passband flatness described above according to the corresponding frequency band.

In other word, the controller 20 varies the voltage Vc applied to the circuit 10 for compensating passband flatness into the preset voltage values according to the frequency bands to control the voltage Vc applied to the varactor diode D11 of the circuit 10 for compensating passband flatness, thereby making it possible to correct the micro resonance frequencies for the passbands of the input signals described above.

Further, the controller 20 can automatically control the operations of the repeater such as output and alarm setting of the mobile communication repeater, etc.

The storage unit 30 stores a table having the preset voltage values applied to the varactor diode D11 of the circuit 10 for compensating passband flatness according to the corresponding frequency bands. The table previously measures the passband flatness compensation values of the repeater for each use band and sets them. Therefore, the controller 20 loads the table stored in the storage unit 30 and applies it to the circuit 10 for compensating passband flatness based on the voltage values capable of correcting the passband flatness for the signals input in the corresponding frequency bands.

Moreover, the storage unit 30 previously measures the passband flatness compensation values for the repeater for each use band and stores them in the table.

For example, if the user selects his/her desired use bands at the time of installing the repeater, the controller 20 loads data values in a table form previously stored in the storage unit 30 and applies the control voltage values corresponding to the use bands based on the voltage values to the circuit 10 for compensating passband flatness, such that it can have the excellent flatness characteristics in the use band.

The key input unit 40 can receive the setting value for the current frequency band or the values setting the setting and alarm monitoring of the repeater and the operations of the repeater.

The display unit 50 performs a role of displaying the setting values and the current state, etc. required for the control of the controller 20. And, the display unit 50 displays the setting screen in a graphical user interface (GUI) form. For example, the user can change the table having the preset voltage value applied to the varactor diode D11 or set the current frequency band according to the corresponding frequency band stored in the storage unit 30 through the setting screen of the display unit 50. Further, the screen displayed on the display unit 50 can be provided to allow the user to be set in an interactive menu form through the key input unit 40.

Moreover, the key input unit 40 and the display unit 50 may be configured of the setting terminal 115 such as PC etc. as shown in FIG. 2. For example, the setting software screen is displayed on the screen of the setting terminal 115 in the graphical user interface form. Then, the user inputs the setting values for the table values to be stored in the storage unit 30 by operating the key input unit 40. And, when the user selects the band to be used, the controller 20 for the repeater applies the input values to the circuit 10 for compensating passband flatness.

Further, the present invention may be configured to change the setting values to be used for the controller 20 at a remote place through a wired and wireless communication network such as Internet, etc. For example, as shown in FIG. 2, the setting terminal 115 includes software capable of changing the setting information required for the controller 20, such that when the band to be used is selected by the setting terminal 115, the values input from the controller 20 can be applied to the circuit 10 for compensating passband flatness.

FIG. 5 is an exemplified diagram showing the passband flatness compensation according to the exemplary embodiment of the present invention. Reference numeral 50 represents the frequency passband characteristics (for example, the passband flatness characteristics for the repeater when there is no the circuit 10 for compensating passband flatness) of the input signal bandpassed through the input circuit 200 as shown FIG. 2 and reference numeral 51 represents passband characteristic provided by the apparatus for compensating passband flatness according to the exemplary embodiment of the present invention. And, reference numeral 52 represents a signal (for example, the final passband flatness characteristic compensated by the circuit 10 for compensating passband flatness) in which passband flatness of input signal is corrected according to the passband characteristic performed by the apparatus for compensating passband flatness.

In other words, the controller 20 generates the compensation signal 51 having the same gradient and size as the input signal 50 whose flatness is distorted are the same and the gradient of different direction therefrom to output the signal 52 whose passband flatness is compensated. That is, the controller 20 electronically controls the characteristics of the circuit 10 for compensating passband flatness such that the passband characteristic for the repeater can have the flat characteristic.

Therefore, the controller 20 of the apparatus 200 for compensating passband flatness controls the voltage Vc applied to the circuit 10 for compensating passband flatness when the service band is changed in areas where any frequency bands are served to vary the voltage of the circuit 10 for compensating passband flatness to make the flatness in the newly changed service bands good, thereby making it possible to serve the optimal flatness in the newly served bands.

With present invention, the manufacturer can simply control the passband flatness of the mobile communication repeater, such that when the manufacturer controls the passband flatness, the trouble of opening the finished products and the inconvenience of recalling the installed repeater due to the defect of the passband flatness can be remarkably reduced.

Further, with the present invention, difficulty in implementing the passband flatness characteristics for the repeater can be solved, the repeater meeting the wide band service and the used variable band characteristics can be easily developed, and the mass-productivity of the developed repeater can be increased. In other words, with the present invention, the development period and the production costs of the repeater can be reduced and the best signal quality can be maintained by maintaining the excellent passband flatness.

Hereinafter, a method for compensating passband flatness according to an exemplary embodiment of the present invention will be described. In the following description, the mobile communication repeater to which the apparatus for compensating passband flatness of FIG. 2 is applied will be described by way of example. Further, reference numerals shown in FIGS. 2 to 5 represent the same components.

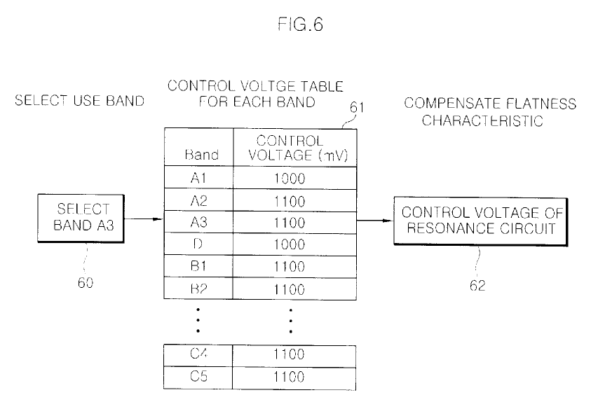

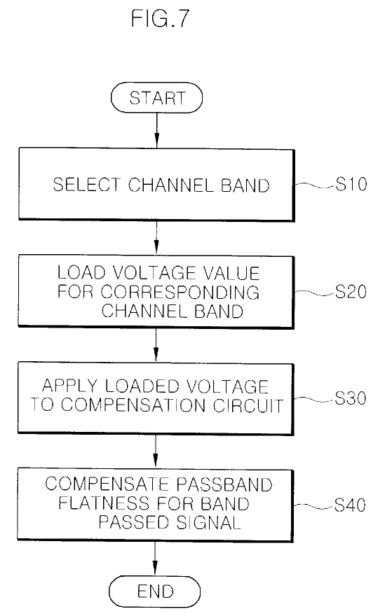

FIG. 6 is a diagram for explaining the method for compensating passband flatness according to the exemplary embodiment of the present invention and FIG. 7 is a block diagram showing the method for compensating passband flatness according to the exemplary embodiment of the present invention.

Referring to FIGS. 6 and 7, the controller 20 first loads and displays a control voltage table 61 for each band stored in the storage unit 30 through the display unit 50. At this time, as described above, the compensation values of the passband flatness for the repeater for each use band are previously measured and stored at the table in the storage unit 30.

Next, the user select the frequency bands 60 corresponding to the areas where the mobile communication repeaters are installed on the screen displayed on the display unit 30 (S10). Herein, it is assumed that band A3 shown in FIG. 6 is selected.

Thereafter, the controller 20 refers to the previously stored data value in the table form through the storage unit 30 and loads a control voltage value (1100 mV) to be applied corresponding to the use band (S20). And, the controller 20 inputs the control voltage value loaded into the circuit 10 for compensating passband flatness (S30). Then, as described above, the capacitance component 62 of the varactor diode D11 is changed such that the passband flatness for the input signal is compensated (S40).

For example, when A3 band which is displayed on the screen of the display unit 50 shown in FIG. 6 is selected, control voltage to be applied to the circuit for compensating passband flatness is converted into preset value of 1100 mV (an output voltage with respect to a reference voltage) based on 4095 that is a maximum value of a 12 bit D/A converter (0 to 4095 in the range of a detailed adjustment value). The ripple of the repeater is changed by the voltage. Therefore, the present invention controls the passband flatness characteristic for the input signal of the mobile communication repeater by the controller 20 according to the selection of the optimal setting value in a software manner, thereby making it possible to control the flatness of the use band through a program.

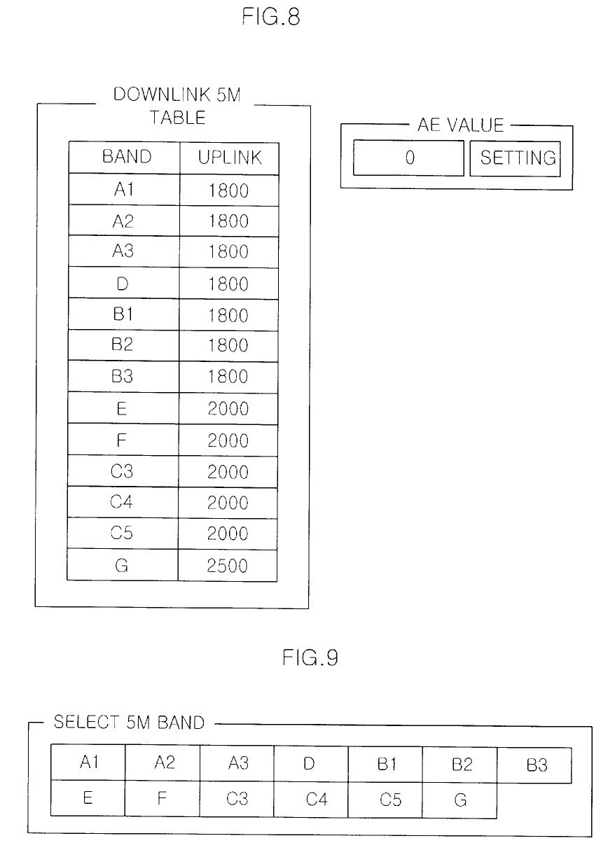

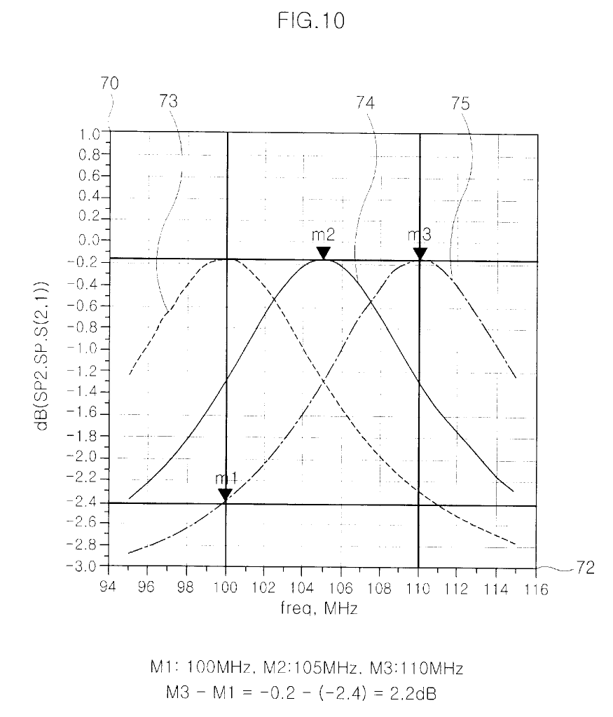

FIG. 8 is a frequency band setting screen displayed on the display unit 50 and FIG. 9 is a graphical user interface screen.

Referring to FIG. 8, the graphical user interface (GUI) of the optimal value setting software for applying the apparatus and method for compensating passband flatness according to the exemplary embodiment of the present invention shown in FIG. 6 is shown. The repeater is operated with the setting value by inputting an AE value of FIG. 7, setting a value meeting the corresponding band, and storing it.

Referring to FIG. 9, the graphical user interface screen is shown. When the band to be used is selected by the key input unit 40, the graphical user interface screen is a screen for applying the value input from the controller 20 of the repeater to the circuit 10 for compensating passband flatness and setting it in a software manner to be able to compensate the flatness.

FIG. 10 is a diagram showing actually measured resonance characteristics of a circuit for compensating passband flatness for a mobile communication repeater according to an exemplary embodiment of the present invention. Reference numeral 70 represents a loss value, reference numeral 72 represent a frequency band, and reference numerals 73, 74, and 75 represents loss values of frequencies when the passband flatness is compensated by the circuit 10 for compensating passband flatness.

Referring to FIG. 10, the controller 20 changes the voltage applied to the variable capacity varactor diode corresponding to the varactor diode D11 of the circuit 10 for compensating passband flatness to change the capacitance value of the variable capacity varactor diode, thereby moving the resonance frequency of the resonance circuit that is applied to the present invention.

For example, service providers in specific countries, in particular, US should meet the passband flatness characteristic within 1.25 dB even if any bands are selected within the overall band of 65 MHz. However, since the band is wide and the frequency gap between the transmission/reception bands is very small to 15 MHz, it is really difficult to meet the flatness characteristic within 1.5 dB over the overall bands of 65 MHz. Therefore, in the case of 100 MHz, reference numeral 73 represents a loss of −0.2 dB, reference numeral 74 represents a loss of −0.4 dB, and reference numeral 75 represents a loss of −2.4 dB, with respect to the resonance frequency.

For example, as the resonance frequency moves from the lowest frequency to the highest frequency of a set IF band, the gradient of the flatness of the resonance circuit at the IF band changes from − to +. The resonance circuit is applied to the repeater, such that a circuit improving the flatness characteristic for the repeater can be provided.

As described above, the present invention can previously measure the passband flatness compensation values for the repeater for each use band and store them as data in the table form, when there are a large number of cases of the selectable service bands.

Further, the present invention refers to the previously stored data values in the table form to select the users desired use bands at or after the installation to apply the control voltage values of the resonance circuit corresponding to the use band to the resonance circuit, such that the flatness characteristic optimized for the use band can be provided.

Further, the present invention can use more than two or three compensation circuits when the band is wide and the frequency gap between the transmission/reception bands is small. The compensation circuit used in order to apply the optimized value can be selected (only one of several compensation circuits can be selected or a plurality of compensation circuits can be applied) in a software manner and the voltage values to be applied to the compensation circuits can be selected in a software manner. When the plurality of circuits 10 for compensating passband flatness are applied, since they are optimized at a value other than the voltage value when only one compensation circuit 10 is applied, separate data can be managed/applied in the table form so that the voltage value can be applied when the plurality of compensation circuits are applied.

Further, the present invention can provide a function of accessing the repeater by remote and setting it to improve the maintenance of the previously installed repeater.

As described above, although the technical ideas of the exemplary embodiments are described with reference to the accompanying drawings, the best exemplary embodiment of the present invention illustrates by way of example only and the present invention is not limited thereto. Further, it is apparent to those skilled in the art that various modifications and changes can be made without departing from the technical scope of the present invention.

What is claimed is:

1. An apparatus for compensating passband flatness for a mobile communication repeater to compensate passband flatness of band passed input signals comprising:
a circuit for compensating passband flatness that includes a varactor diode formed to be connected to an inductance element to correct micro resonance frequencies for the passbands of the input signals according to voltages applied from the outside; and
a controller that variably controls voltages input to the circuit for compensating passband flatness according to current frequency bands and varies the voltages applied to the varactor diode based on preset voltage values applied to the varactor diode so that passband flatness characteristics are compensated according to the corresponding frequency bands.

2. The apparatus for compensating passband flatness for a mobile communication repeater according to claim 1, further comprising a storage unit that stores a table having the preset voltage values applied to the varactor diode so that the passband flatness characteristics are compensated according to the corresponding frequency bands,
wherein the controller variably controls the voltages input to the circuit for compensating passband flatness according to the current frequency bands based on the table stored in the storage unit.

3. The apparatus for compensating passband flatness for a mobile communication repeater according to claim 2, further comprising a key input unit that receives setting values for the current frequency bands.
wherein the controller loads the table stored in the storage unit according to the setting values for the current frequency bands input from the key input unit and inputs the corresponding voltage values to the circuit for compensating passband flatness.

4. The apparatus for compensating passband flatness for a mobile communication repeater according to claim 3, further comprising a display unit that displays the table stored in the storage unit in a user interface form.

5. The apparatus for compensating passband flatness for a mobile communication repeater according to claim 1, wherein the circuit for compensating passband flatness includes a basic resonance element unit that determines the passbands of the inputs signals; and
the varactor diode formed to be connected to the inductance element to correct the micro resonance frequency for the passband of the basic resonance element unit according to the voltages applied from the outside.

6. The apparatus for compensating passband flatness for a mobile communication repeater according to claim 5, wherein the varactor diode is connected to the inductance element in parallel.

7. A method for compensating passband flatness for a mobile communication repeater to compensate passband flatness of a band passed input signal comprising:
receiving setting values of current frequency bands from outside; loading preset voltage values applied to a varactor diode to compensate passband flatness characteristics according to the setting values of the input current frequency bands; and
variably controlling voltages input to a circuit for compensating passband flatness that includes a varactor diode to be formed connected to an inductance element to correct micro resonance frequencies for the passbands of the input signals according to the voltages applied from the outside based on the loaded value voltage.

8. The method for compensating passband flatness for a mobile communication repeater according to claim 7, further comprising storing a table having the preset voltage values applied to the varactor diode so that the passband flatness characteristics are compensated according to the corresponding frequency bands,
wherein the controlling variably controls the voltages input to the circuit for compensating passband flatness according to the current frequency bands based on the table stored in the storing step.

9. The method for compensating passband flatness for a mobile communication repeater according to claim 8, wherein controlling loads of the table stored in the storing step according to the setting values for the current frequency bands input in the inputting step and input the corresponding voltage values to the circuit for compensating passband flatness.

10. The method for compensating passband flatness for a mobile communication repeater according to claim 7, further comprising displaying the table stored in the storing step in a user interface form.

11. A circuit for compensating passband flatness for a mobile communication repeater to compensate flatness of band passed input signals comprising:
a basic resonance element unit that determines passbands of the inputs signals; and
a varactor diode formed to be connected to the inductance clement to correct the micro resonance frequencies for the passband of the basic resonance element unit according to the voltages applied from the outside.

12. The circuit for compensating passband flatness for a mobile communication repeater according to claim 11, wherein the varactor diode is connected to the inductance element in parallel.

13. A mobile communication repeater comprising:
a circuit for compensating passband flatness that includes a varactor diode formed to be connected to an inductance element to correct micro resonance frequencies for passbands of input signals according to voltages applied from the outside; and
a controller that controls voltages input to the circuit for compensating passband flatness according to a current frequency band and varies the voltages applied to the varactor diode of the circuit for compensating passband flatness based on preset voltage values applied to the varactor diode so that passband flatness characteristics are compensated according to the corresponding frequency bands.
